(19) United States
(12) Patent Application Publication
(10) Pub. No.: US 2016/0370239 A1
(43) Pub. Date: Dec. 22, 2016

(54) Body Motion Assessment Using Image Analysis

(71) Applicant: Peter M. Cummings, Beverly, MA (US)

(72) Inventor: Peter M. Cummings, Beverly, MA (US)

(21) Appl. No.: 15/161,984

(22) Filed: May 23, 2016

Related U.S. Application Data
(60) Provisional application No. 62/165,753, filed on May 22, 2015.

(51) Int. Cl. G01L 5/00; G06T 7/00; G06T 7/20

(52) U.S. Cl. CPC G01L 5/0052; G06T 7/2073; G06T 7/004; G06T 7/0018; G06T 2207/30241; G06T 2207/10016; G06T 2207/30196

(57) ABSTRACT

Sensors or a sensing system are employed in a given space to detect position, velocity and/or acceleration of one or more bodies and/or one or more portions of one or more bodies. The sensing is employed, in whole or in part, remotely from the body or bodies being sensed. The results of sensing are employed to determine forces applied to the body or bodies. A determination is made as to whether the determined forces are beyond a threshold level that is likely to result in damage or functional status change to the body or bodies.

### BACKGROUND

Motion detection for an independent body, such as a human individual, has been achieved using wearable or carried devices. For example, in the case of motion detection related to sports activities, specialized sensors may be incorporated into the sporting equipment, apparel or wearable device suitable for the participant.

An area of interest for motion detection in sports activities is detection of high accelerations, as may be observed in events leading to concussive injuries, for example. Detection of such high acceleration events has typically been achieved using specialized sporting equipment. For example, helmets, mouth guards or mesh garments may be equipped with specialized sensors that can detect motion or high accelerations. The specialized sensors may be customized for the application, such as by being customized to the item in which a specialized sensor might be incorporated, which can add to their deployment cost.

When used in a sports activity environment, these technologies tend to be focused mainly on football and incorporation of sensors in football equipment, likely due to the potential for greater incidences of injury in that sport. In addition, it may be more challenging to use motion detection sensors in other sports due to use of less safety equipment in some instances. Sports such as soccer, lacrosse, ice hockey, and skiing all have the potential for concussive and other injuries, however, challenges remain for applying motion detection sensors in these activities. In addition, sporting equipment can sometimes be knocked off an individual during a sporting event, and transfer of motion detection sensors between different pieces of equipment may be difficult if not entirely impractical.

### SUMMARY

Implementations and techniques discussed herein may provide one or more of the following capabilities, as well as other capabilities not mentioned. Sensors or a sensing system may be employed in a given space to detect position, velocity and/or acceleration of one or more bodies and/or one or more portions of one or more bodies. The sensing may be employed, in whole or in part, remotely from the body or bodies being sensed. The results of sensing may be employed to determine forces applied to the body or bodies. A determination may be made as to whether the determined forces are beyond a threshold level that is likely to result in damage to the body or bodies.

According to an example, the sensing may be implemented using an image capture device to capture an image of one or more bodies and/or one or more portions of one or more bodies. The captured images may be obtained with one or more image capture devices, such as cameras that may capture single images and/or streams of images (video). The captured images may include portions or all of one or more individuals involved in an activity in the given space. The space may be one or more athletic playing fields, playgrounds, backyards, indoor/outdoor courts, ice rinks, skateboard parks, roller skating rinks, bicycle racing courses/bicycle parks and/or ski slopes, as non-limiting examples.

The captured images may be analyzed to detect body motion, which may include portions of or complete bodies of individuals involved in the activity. The analysis may be conducted to detect physical phenomena, such as position, velocity and/or acceleration, in one or more dimensions and/or in one or more coordinate systems. For example, the analysis may be conducted to detect linear, torsional or angular phenomena. Linear phenomena occurs in one or more dimensions that may have a single directional characteristic. Examples include straight line position, velocity and/or acceleration. Torsional phenomena is observed when an object is twisted or experiences an applied torque, and may be described in terms of position, velocity, acceleration, torque and/or moment. Angular phenomena occurs along an angular or arcuate path, and may include position, velocity and/or acceleration.

The body sensing and analysis of the sensing results can be used to make a determination of applied force to the body or a portion thereof. A determination can be made, for example, of composite force applied to a head of one or more individuals involved in the activity. The level of force can be used to estimate concussive impact and risk of injury.

According to an example of the present disclosure, a method remotely determines force applied to an object by remotely sensing a first position of the object at a first time and remotely sensing a second position of the object at a second time that is later than the first time by an elapsed time. The method includes determining a distance between the first position and the second position and calculating force applied to the object using the distance and the elapsed time. The example method may also include detecting a collision between the object and another object during an interval between the first time and the second time.

The example method may include capturing an image that includes at least a portion of the object or determining a distance resolution of the image in a region of the image that includes at least the portion of the object. The example method may also include capturing a first image of at least the portion of the object at the first position, and determining a first distance resolution for at least the portion of the object in the first image. The example method may also include capturing a second image of at least the portion of the object at the second position and determining a second distance resolution for at least the portion of the object in the second image. The distance between the first position and the second position may be determined by interpolating a distance measurement between at least the portion of the object in the first image and at least the portion of the object in the second image in accordance with the first distance resolution and the second distance resolution.

Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE SEVERAL VIEWS OF THE DRAWINGS

Example implementations are described in greater detail below, with reference to the accompanying drawings, in which:

FIG. 1 is a diagram illustrating placement of sensors and sensing fields in an area of interest;

FIG. 2 is a diagram illustrating use of an overhead sensor and sensing field;

FIG. 3 is a diagram illustrating position change detection;

FIG. 4 is a vector diagram illustrating calculation of a resultant vector;

FIG. 5 is a diagram illustrating image capture perspectives;

FIG. 6 is a block diagram of a computer system;

FIG. 7 is a block diagram of functional modules; and

FIG. 8 is a flowchart illustrating an example method for calculating force applied to an object in a collision.

### DETAILED DESCRIPTION

This application claims the benefit of U.S. Provisional Application No. 62/165,753, filed May 22, 2015, entitled “BODY MOTION ASSESMENT USING IMAGE ANALYSIS,” the entire disclosure of which is hereby incorporated by reference herein. Implementations and techniques are discussed herein for sensing one or more bodies or portions thereof, which bodies may or may not interact. The sensed body, bodies, or portions thereof are referred to collectively herein as “body” or “bodies” in context. The sensing may be achieved through image capture using an image capture device directed towards a given space. The sensing may be remote from the body, and may work in combination with indicia or devices located on the body. The captured images may be obtained for a given space that may be defined on one or more dimensions. The image(s) captured by the image capture device may be subjected to analysis to determine physical phenomena acting on the body. The physical phenomena may be used to make a determination of potential damage or injury to the body. Such a determination may be used to apply preventative treatments, diagnoses and/or other steps or treatments to identify whether injury has occurred, to determine a level of injury and/or to address the injury.

According to an example, the physical phenomena is a resulting force acting on the body and is determined based on measuring phenomena such as position, velocity and/or acceleration of a given point on the body. The resulting force may be determined if the acceleration and mass of the body are known, such as by using scalar or vector versions of the equation F=ma, where F is the force, m is the mass and a is the acceleration. The force may be compared to a threshold force level to assess the effect of the force. For example, a threshold may be used where force at or below the threshold is considered nominal. Alternatively, or in addition, another threshold might be used to indicate that the body or individual experiencing the force might suffer damage or injury and should be evaluated. Yet another threshold might be used alone or in combination with other thresholds, and may be used to indicate a high probability of damage or injury and/or that a diagnosis or treatment should be applied.

A g-force of 80 g is often used as a general level of force for determination of an injurious level of force. For example, an 80 g g-force may be used as a threshold for determining that concussive force is applied to an individual, meaning that observation of that level of force may have a statistically significant probability of resulting in a concussion. Other thresholds may be used, or used in combination with other parameters. For example, a single dimension vector of force may be compared against a lower threshold, for example 60 g of g-force, to determine whether an injurious force is observed. Different thresholds may be used for different participant groups, for example lower thresholds for younger participants, or higher or lower thresholds or additive thresholds based factors such as sport type, gender of participant, ages, and any other factors that may implicate different levels of force to be considered nominal, likely injurious, or dangerous applied forces. The range of force thresholds is not limited, and, in accordance with the present disclosure, is meant to cover all activities in which an object might experience an applied force that can potentially be damaging or injurious.

According to an example, image capture is performed to capture images of an object or body that can be subjected to motion, and/or that may be involved in a collision with another object or body. The terms object and body are used interchangeably herein to refer to an item under inspection in accordance with the techniques and implementations discussed herein. The image capture may be performed by a camera, which may be digital or analog, and capturing single frames or a series of frames (video) of image data. The camera may be configured to follow the body under motion, or may be directed to an area of interest that includes the body. The captured images are analyzed to obtain data on physical phenomena such as position, speed, acceleration and deceleration of the body, which may be a portion or an entirety of one or more individuals. The analysis may be conducted with reference to a point identified in the images, including a point on the body. The camera, or other sensing equipment, may also capture biometric data, including temperature, heart rate, or other data on an individual that may be sensed remotely. The data obtained through the analysis is used to generate a g-force acting on the body. For example, an acceleration determined with the analysis may be converted to a force as described above. The remote sensing of forces acting on the body permits individuals to be monitored for being subjected to excessive force without the need for special and/or additional athletic equipment.

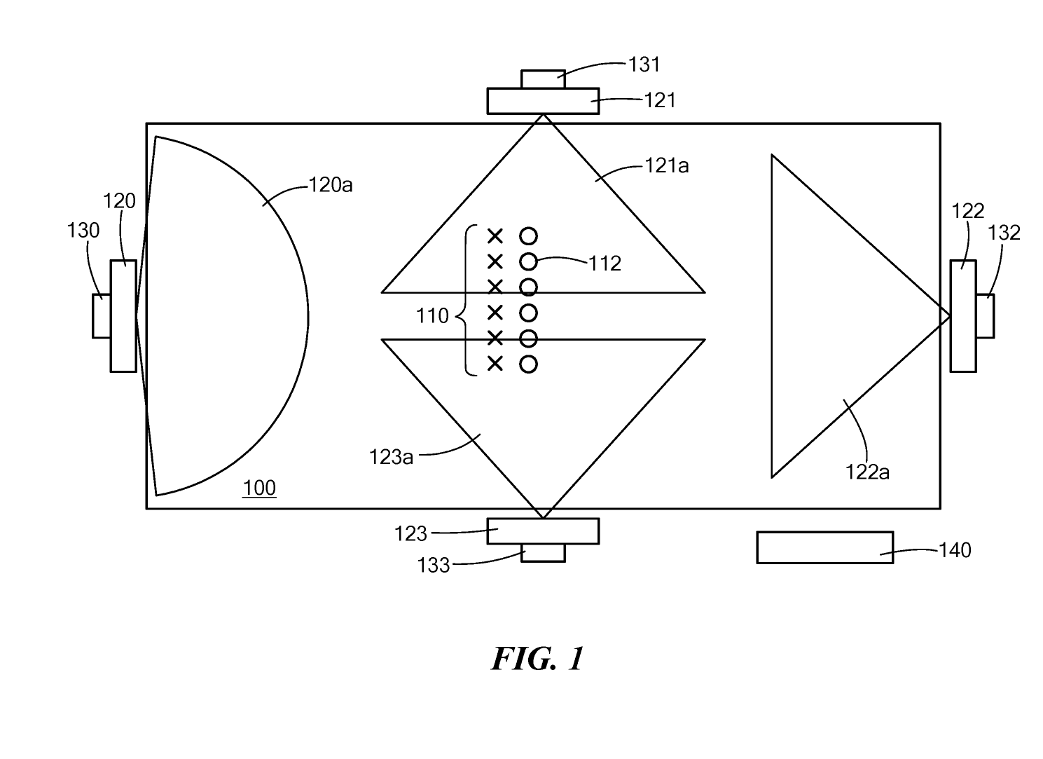

Referring to FIG. 1, a plan view of an area 100 is illustrated. Area 100 represents a region of space in which one or more bodies 110 may be located, and which is monitored in accordance with the present disclosure. Sensors 120, 121, 122 and 123 are arranged around area 100 to sense one or more bodies 110. One or more of sensors 120-123 may be image capture devices, such as analog or digital scanners or cameras, which may be capable of capturing image information in one or more dimensions, including 2D or 3D. One or more of the image capture devices may be video cameras that capture images at a certain frame rate, such as 30 frames a second for NTSC (National Television System Committee) video, which is generally used in North America and Japan.

Other types of devices may be used for one or more of sensors 120-123, including infrared cameras, ultrasonic sensors, lasers, radio frequency (RF) timing systems, radar, or any other type of device or system that can measure position remotely. Items such as retroreflectors, barcodes, passive or active signaling equipment and/or other indicia may be deployed on one or more bodies 110. Such items may be used in conjunction with one or more of sensors 120-123 to monitor bodies 110. For example sensors 120-123 may be used with such items to track, identify or measure physical parameters related to one or more bodies 110, including parameters such as position, velocity and/or acceleration. Any type of functionality that is possible with sensors 120-123, with or without the use of such body-deployed items, may be utilized in monitoring bodies 110.

Sensors 120-123 may also be configured to track one or more of bodies 110, for example a body 112. The tracking may be achieved by one or more sensors 120-123 physically moving with movement of body 112. In addition, or alternatively, sensors 120-123 may track indicia or body 112 within a given frame of reference, such as an image frame or predefined virtual space. Any other type of tracking may be used based on the functionality made possible with the use of sensors 120-123.

Sensors 120-123 are located at various positions to permit monitoring of portions or all of area 100. Area 100 may be a playing field, playground, backyard, court, rink, skate park, ski slope, or any other type of area where bodies, including bodies 110, may be positioned and/or in motion. Sensors 120-123 may be fixed in location or moveable. Sensors 120, 121, 122 and 123 may be arranged to have respective sensing fields 120a, 121a, 122a and 123a. The breadth or range of sensing fields 120a-123a may depend on the nature of area 100, and/or the type or configuration of sensors 120-123. For example, one or more of sensors 120-123 may be fixed and have a fixed or variable respective sensing field 120a-123a. One or more of sensors 120-123 may be moveable in position and have a fixed or variable respective sensing field 120a-123a. A sensing field in sensing fields 120a-123a may preferably be fixed when a respective sensor in sensors 120-123 is moveable to simplify calculations and data collection.

One or more of sensors 120-123 may be arranged to be fastened to utility poles, standing light fixtures, playground equipment, field goal posts, trees, goals (soccer, hockey, field hockey, lacrosse, e.g.), secured to tripods or other stationary structures around or in area 100, including being suspended from a device such as a crane or ceiling, or any other arrangement with a fixed position. The position of sensors 120-123 may be established in a frame of reference relative to area 100. For example, a position of one or more sensors 120-123 may be established in one or more dimensions in accordance with a system of coordinates that can be arbitrarily set. In the case of a three dimensional coordinate system with perpendicular axes labeled X, Y and Z, the position of sensors 120-123 may be established as a vertical height above ground along the Z axis, a distance from an arbitrarily set origin along the X axis and a distance from the origin along the Y axis. With such a known position for sensors 120-123, a position of bodies 110 can be established with reference to area 100 using sensors 120-123 and the coordinate system. Other coordinate systems may be used in one or more dimensions, as long as a frame of reference can be established with area 100.

Moveable placements of one or more of sensors 120-123 is also possible, including but not limited to overhead placements, as might be achieved with remote control drone devices or overhead suspended tracks or wires, which may include shuttle devices that can move a sensor along the tracks or wires. Such overhead placements may be inside or outside the perimeter of the area. Other configurations are possible, including tracks or wires located near to ground or a floor of area 100, where a sensor can be moved along the tracks or wires. Any other type of moveable configuration can be used for sensors 120-123, as long as respective sensing fields 120a-123a can be directed at bodies 110 in area 100.

Sensors 120-123 may include or be collocated with a respective position detection device 130, 131, 132 or 133. Position detection devices 130-133 are mechanisms that include position sensing equipment for sensing a position relative to one or more dimensions or axes. For example, a position detection device 130-133 may include equipment to measure its height above a ground surface and/or its position along one or more axes in an arbitrary coordinate system. Position detection devices 130-133 may use accelerometers and/or transceivers to generate inertial navigation system (INS) position data or satellite based position data, such as global navigation satellite system (GNSS) data or global positioning (GPS) data. Position detection devices 130-133 can provide position information for one or more of sensors 120-123 relative to area 100 to permit position information for bodies 110 to be obtained using sensors 120-123. Sensors 120-123 may be fixed or moveable in position, and position detection devices 130-133 may be used to update the position of one or more of sensors 120-123.

Position detection devices 130-133 may be calibrated or initialized for position detection. In the case of being fixed in position, or providing position information on any of sensors 120-123 that are fixed in position, position detection devices 130-133 can be calibrated to a position, or to report a position of any of sensors 120-123, in a coordinate system or frame of reference related to area 100 based on measured parameters. For example, position detection devices 130-133 can be provided with position values, such as height above ground or a floor, and/or distance along a coordinate axis from an origin point, which are fixed with respect to area 100. Using such calibration or initialization, position detection devices 130-133 can report positions of any fixed sensors 120-123 for use in calculating positions of bodies 110 that are monitored by such fixed sensors 120-123 with accuracy, precision and repeatability.

If any of sensors 120-123 are moveable, and/or any of position detection devices 130-133 are moveable, positions of such moveable sensors 120-123 can be detected and updated on an ongoing basis. For example, GNSS/INS systems may be employed in one or more of position detection devices 130-133 to track and update a position of such moveable sensors 120-123. Any other type of position tracking system may also or alternatively be used to provide position information on such moveable sensors 120-123. With updated position information for such moveable sensors 120-123, and a relationship between such position information and area 100, an accurate, precise and repeatable position measurement of bodies 110 can be made.

Sensing fields 120a-123a can be configured to be directed to a region of interest in area 100, or to encompass all of area 100. For example, one or more of sensors 120-123 may be implemented as a pan-tilt-zoom (PTZ) camera that can provide a series of images including video. The PTZ functionality of the camera(s) can be used to focus on a region in the area of interest, or the entire area of interest, for example a playing field. One or more of sensors 120-123 may be configured to operate in real-time to permit real-time monitoring of bodies 110 in a portion or an entirety of area 100. Multiple ones of sensors 120-123 may be configured to have a same or overlapping sensing field 120a-123a. The overlap of sensing fields 120a-123a may permit observation of bodies 110 from different angles and separate or conjunctive calculations of force. The different locations of sensors 120-123 permits collection of data from multiple angles. The data from different and overlapping sensing fields 120a-123a may be synchronized to permit coordinated calculations of force to be made, separately or in combination.

One or more of sensing fields 120a-123a may be variable, which may achieved by using the PTZ functionality of a respective sensor 120-123 and/or by moving one or more of sensors 120-123 and/or by using other techniques for varying sensing fields 120a-123a The PTZ functionality may also be used to track a body by panning, tilting and/or zooming with the movement of the body. The PTZ functionality may be used to obtain a particular image aspect of the body in an image frame, such as, for example, a head and shoulders of body 112. Together with the knowledge of the settings of a PTZ camera, the position of body 112 within an image frame can be used to detect the actual position of body 112 with respect to area 100. As a position of body 112 changes, and is captured with a PTZ camera tracking body 112, position calculations can be performed with greater accuracy or smaller tolerances to obtain more certain results on calculated force. Any of the position sensing discussed herein can be used in conjunction with timing information, such as frame rate, to determine other parameters such as velocity or acceleration, in an arbitrary coordinate system.

All of the bodies in area 100 can be monitored using sensors 120-123, including each of bodies 110. For example, multiple imaging devices located in various different positions may be used to monitor an entirety of area 100 and each individual in area 100 in real-time. Sensors 120-123 and/or position detection devices 130-133 may be battery powered, solar powered, connected to a line power source, or be powered with any suitable power source. Sensors 120-123 and/or position detection devices 130-133 may be equipped with or have access to transceivers for communicating data to a computer 140, which is also equipped with or has access to complementary transceivers. The transceivers may be wireless or wired, and may include one or more antennas for sending or receiving signals. For example, data can be communicated from sensors 120-123 to computer 140 using Bluetooth® or WiFi signals, and/or using universal serial bus (USB), Ethernet, Firewire, Internet or any other suitable communication technique or protocol. The data may be encrypted or otherwise protected from eavesdropping or copying. Computer 140 is a secure computer that may be encrypted and/or secured with password protection or other security measures.

Computer 140 may be incorporated into or distributed among one or more of sensors 121-123. A number of computers may be used to form computer 140, which computers may be local with or remote from area 100. Computer 140 is capable of collecting and analyzing data from sensors 121-123, however, some tasks carried out by computer 140 may be done by hardware or software modules that are designated for certain tasks. The modules may be separate computers, processors, cores, applications or other distinct computational operators that can collectively or individually be referred to as computer 140. Computer 140 may include a display or other peripherals such as input devices like a mouse or keyboard. Computer 140 may include various network connections, including internet, Bluetooth, WiFi, USB, Ethernet, Firewire, or any other communication network interface or connection. Computer 140 may include storage, such as mass storage including hard drives, solid state drives or other large capacity storage, and/or storage such as ROM, RAM and the variations on such storage that might be used by one or more processors or cores executing an application. Computer 140 may include other peripherals for storage, including USB drives, DVD drives or other electrical, electromagnetic, magnetic or optical storage.

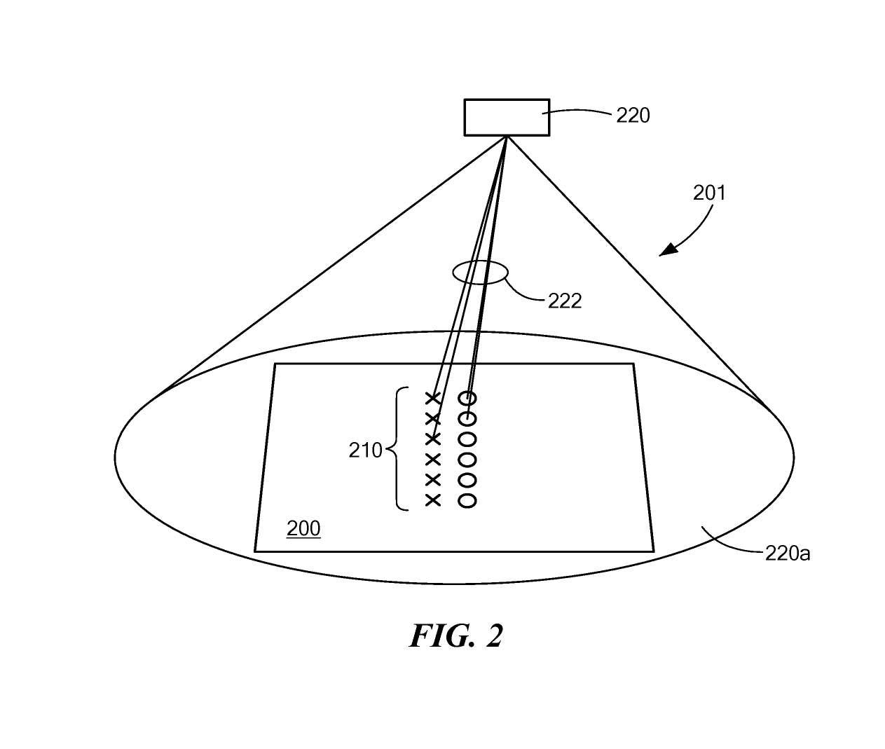

Referring to FIG. 2, a surveillance system 201 for monitoring bodies 210 is illustrated. System 201 includes a sensor 220 that may include a position detection device for detecting position of sensor 220 and/or a transceiver for communicating data and/or a computer for calculating force values. Sensor 220 is configured to have a sensing field 220a that covers an entirety of area 200. Various ones of bodies 210 can be targeted or identified by sensor 220, as indicated with lines 222. The position of sensor 220 is known with respect to area 200, so that a position of each of bodies 210 can be determined with respect to area 200 and with respect to each other. Calculations may be performed using position data for bodies 210 obtained from sensor 220, along with timing information, to determine other parameters such as velocity, acceleration and/or force, for example. Sensor 220 may be implemented as sensors 120-123, and may be provided with the features of position detection devices 130-133, transceivers and/or computer 140 as described above.

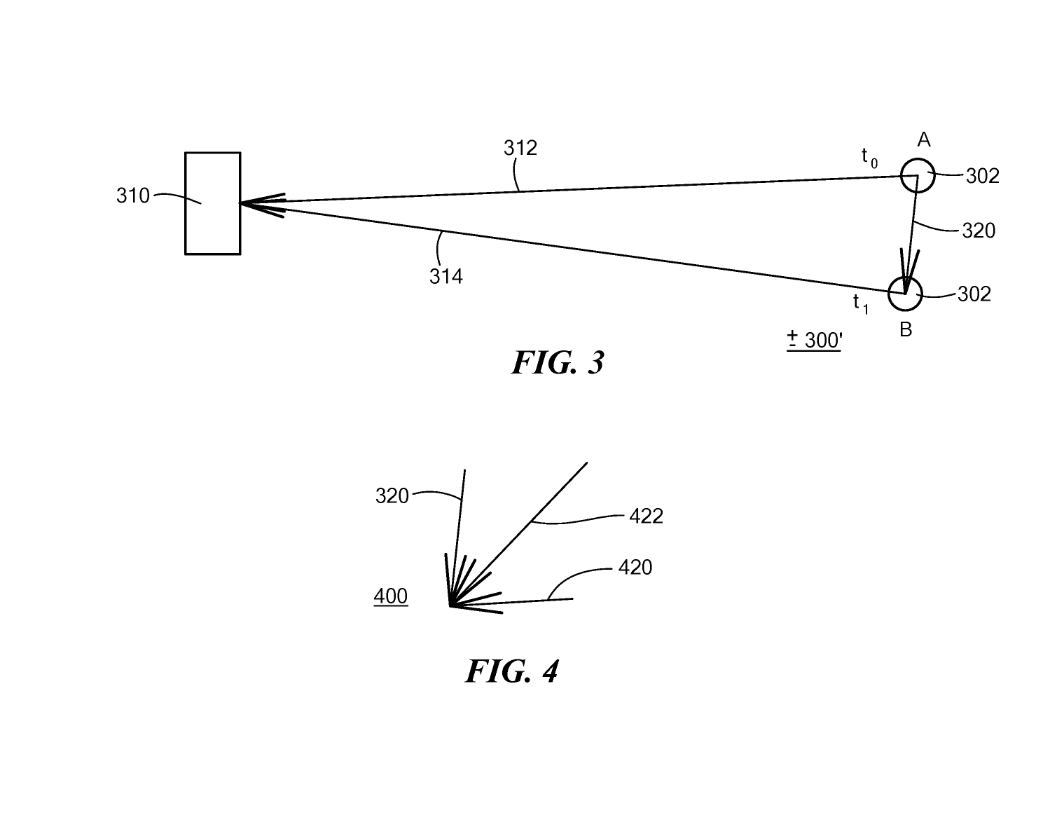

Referring to FIG. 3, a diagram 300 illustrates the detection and analysis of phenomena recorded by a sensor 310, which may be implemented as any of sensors 120-123 or sensor 220. Sensor 310 detects movement of an object 302, which may be a body as discussed above. Object 302 moves from a point A to a point B, as represented by a vector 320. Object 302 may be subjected to a force or acceleration over one or more portions of or the entire path from point A to point B. For the purposes of example, a force or acceleration applied to object 302 is assumed to be linear and acting in a straight line direction along the path between point A and point B. It should be understood that the presently disclosed techniques and implementations can be used to analyze forces or accelerations that are not linear or acting in a straight line.

Point A and point B can be two different points detected by sensor 310 as object 302 is in motion. Sensor 310 may also be in motion or fixed relative to a frame of reference, such as area 100 (FIG. 1). Thus, diagram 300 depicts the motion of object 302 with reference to sensor 310. Sensor 310 receives a signal from object 302, which may be in the form of, for example, a laser, radar or ultrasound return signal based on a respective signal originating from the vicinity of or from sensor 310. The signal received by sensor 310 may also be image based, for example when sensor 310 is implemented as a camera. Sensor 310 receives a signal and captures the position of object 302 at point A at time t₀, as indicated with line 312. Object 302 moves to point B at time t₁, where sensor 310 receives another signal and captures the position of object 302 as indicated with line 314. The distance from point A to point B can be measured based on the position of sensor 310, the distance represented by lines 312, 314 and the resolution of the signals captured by sensor 310. A classical definition of resolution for a visual image provides for a measurement of the closeness of lines that can be visually resolved. Another way to view resolution is by the capability to observe or measure the smallest object in a signal, such as in an image, clearly with distinct boundaries. The resolution of an image contributes to defining the term “distance resolution” as used herein. Distance resolution is the capability of determining a distance depicted in an image based on the resolution of the image.

For example, sensor 310 may capture images that are represented with pixels, where each pixel represents a length that depends on the resolution of the pixels and the distance of point A and point B from sensor 310. The length of vector 320 can be determined based on how many pixels occupy the space between point A and point B. For example, if each pixel represents an inch at the distance represented by each of lines 312, 314, then a length of vector 320 can be determined in inches based on the number of pixels between point A and point B as observed by sensor 310.

Referring also to FIG. 4, a vector diagram 400 illustrates a composite distance vector 422 formed by adding vector 320 (FIG. 3) and a distance vector 420. Vector 420 may be obtained from another sensor (not shown) similar to sensor 310 but located at another position to detect a distance that object 302 moves in a transverse direction to that detected by sensor 310. The detection of vector 420 may include detection or use of all the parameters discussed above regarding sensor 310. Thus, vector 420 represents collection of some or all of the same information collected by sensor 310. Vector 420 represents movement of object 302 from point A to point B along another axis that is transverse to an axis that sensor 310 is arranged to monitor. Adding vectors 320 and 420 results in vector 422, the magnitude of which represents a composite distance in at least two dimensions traveled by object 302 from point A to point B. The magnitude of vector 422 may be used as a distance measure in calculating velocity, acceleration and force applied to object 302, as discussed in greater detail below with reference to equations for motion.

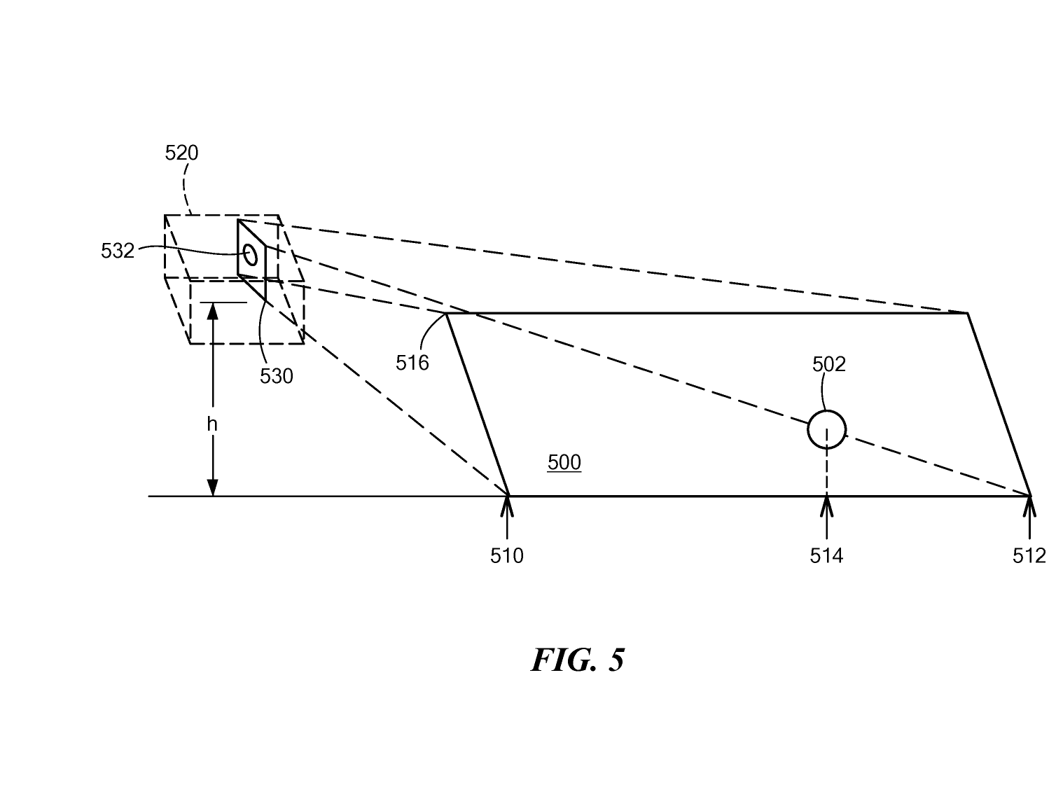

Referring again to FIGS. 1 and 2, as well as to FIG. 5, distances are detected using sensors 120-123 and/or 220 in respective areas 100, 200 and an area 500. Area 500 is monitored with a sensor 520, shown in dashed lines. Sensor 520 is located at a height above a ground point or floor that is contiguous with area 500. Sensor 520 is, for example, an image capture device that is capable of capturing an image 530. Image 530 represents an entirety of area 500, as indicated with the dashed lines connecting the corners of image 530 and area 500. Image 530 is depicted as being housed in sensor 520 and representing a projection of area 500. An object 502 is located in area 500 and depicted in image 530 as object 532.

Image 530 as captured by sensor 520 has a resolution defined by the capability to observe or measure the smallest object clearly with distinct boundaries. The projection of area 500 onto image 530 is at an angle, so that some portions of area 500 are further away from sensor 520 than other portions. The resolution of area 500 in image 530 may be variable from one side of the image to another, since a point 510 of area 500 is closer to image 530 than a point 512. A classical definition of resolution provides for a measurement of the closeness of lines that can be visually resolved. In image 530, lines from point 510 can be closer to each other and still be visually resolved than can lines from point 512. Accordingly, the resolution with respect to distances in area 500 is greater near a bottom of image 530, corresponding to point 510, and lesser near a top of image 530, corresponding to point 512.

Assuming sensor 520 is fixed in position and that its field of view does not change, a position change of objects in area 500, including object 502, can be measured remotely using sensor 520. Sensor 520 is calibrated to incorporate the distance between point 510 and point 512 as a known quantity. The known distance is correlated to the associated positions in image 530. Accordingly, the position of an object in area 500, such as object 502, can be observed and measured in accordance with its correlated position in image 530. In addition, the resolution of image 530 can be calibrated for different portions of the image, so that observations and measurements of items in area 500 can be made based on their appearance in image 530.

For example, assume sensor 520 is configured to have a vertical image resolution of 480 lines per inch. Further assume that sensor 520 is positioned and configured (calibrated) such that a line at a bottom of image 530 that corresponds to point 510 represents 0.5 inches in area 500. Also assume that, with this position and configuration of sensor 530, a line at a top of image 530 that corresponds to point 512 represents 1.0 inches in area 500. This configuration information is provided to computer 140, which can determine an appropriate resolution relationship between a top and a bottom of image 530. For example, the resolution of distances in area 500 between a top and a bottom of image 530 can be determined as a ratio of (i) the distance from a top of image 530 to an object of interest, such as object 532, to (ii) the overall vertical distance of image 530. Using the above noted resolutions for area 500, an object in a vertical center of image 530 would have a 50% ratio of the resolution between the top and the bottom of image 530, or 0.75 inches per line. This resolution can then be used to measure the object using the content of image 530.

The horizontal resolution for image 530 can likewise be calibrated to area 500 using similar techniques. For example, a horizontal resolution of sensor 520 may be 700 lines per inch (700×480 being analog broadcast resolution for NTSC), and a line at the right of image 530 that is associated with point 510 and closer to sensor 520 than a point 516 may correspond to 0.5 inches in area 500, while a line at the left of image 530 that is associated with point 516 that is further from sensor 520 than point 510 may correspond to 0.75 inches in area 500. An object in the horizontal center of image 530 would have a 50% ratio for resolution between the right and left side, or ((0.75-0.5)*50%)+0.5, which is 0.625 inches per line.

Using the above noted calibrations, object 532 in image 530 can be measured for position change and thus velocity. For example, if object 532 changes position by three vertical lines at a center of image 530 between two sequential frames, the change in position can be calculated as 3 lines*0.75 inches/line=2.25 inches. If the frame rate is 30 frames/sec, the velocity can be calculated similarly as 2.25 inches divided by 1/30 of a second or 67.5 inches/sec, which is 5.625 feet/sec. As additional frames of image data are captured, changes in velocity, or acceleration, can be measured.

Other techniques for measuring position changes of an object may be used. For example, an object in an image may be compared against known quantities that are observable in the image. If the object is a football helmet of a football player, for example, and it is known that the height of the helmet is 12.5 inches, the position change of the object can be calibrated based on the helmet dimension in an image. Thus, if the helmet occupies 25 vertical lines, the distance resolution of the image in the location of the object can be estimated at 25/12.5=2 inches per line. This estimate can be used to gage change in position, a velocity and/or acceleration with information collected over a series of frames, as discussed and illustrated above.

The above described technique for calibrating measurements in an image can be used with any type of calibrating indicia in an image. For example, a known length of a logo or other visual indicia that can be located in an image can be used to calibrate the image for measurement as discussed above. Other types of visual indicia can be used, including a venue and/or equipment arrangement. When a sensor such as any of sensors 120-123, 220, 310 or 520 includes a position detection device, so that a position of the sensor with respect to a venue feature is known, distance resolution for an input signal, such as an image, can be calibrated. For example, referring to FIG. 5, points 510 and 512 may be located at visual markers with known characteristics, such as being located at known positions or separated by a known distance. Points 510 and 512 may be, for example, lines on a football or soccer field or on a basketball court. With a known distance between points 510 and 512, and a known position of sensor 520, a measure of a distance on image 530 can be determined or calibrated in accordance with a known resolution of image 530, using the techniques discussed above. Once such a calibration is carried out, measurements of position changes for object 532 can be made, as discussed above.

Other techniques for measuring position changes of objects can be implemented. For example, in the case of radar or ultrasound, the timing of a return signal from an object with the radar or ultrasound frequency can be used to detect position changes of an object. The sensor can be in motion and detect targets using the techniques discussed above to determine relative position changes. An imaging device with zoom capability can vary the distance resolution observed for an object, in which case the zoom factor is used in the calculation of a measure of a position change. In addition, the object may carry indicia, such as a logo or retroreflector that can assist in calibrating an image or laser measurement.

Computer 140 receives data from sensors 120-123, and/or from position detection devices 130-133, which data may be in the form of images or distance measurements, for example. The data may be composed of a series of images, which may be low definition, standard definition or high definition images, and may be provided as a video feed. The frame rate of the images can be any useful rate, including 24, 25, 30, 48, 50, 60 frames/sec or other rates. The image frame rate may be used to determine timing for position measurements for conversion to velocity, acceleration and/or force. The higher the frame rate, the greater the potential for increased accuracy of measurement.

Computer 140 may manipulate the data received from sensors 120-123. For example, computer 140 may be programmed with algorithms for image processing, data filtering or other data conditioning or signal processing techniques. The data may be conditioned for use in extracting information that is input into various methods or techniques to identify a body, body position, body motion or other criteria that may be used for determining a force applied to the body. For example, algorithms related to edge detection, image sharpening, black and white or gray scale conversion, feature extraction and other signal processing and/or image processing techniques may be employed.

According to an example, the computer surveillance system illustrated in FIG. 1 can obtain and compile multiple images received from each one of sensors 120-123 implemented as digital imagers. The images received from sensors 120-123 may be processed as an image stream, and can be treated as images describing one or more dimensions. For example, an image stream can be compiled as a single three dimensional image stream that can be manipulated by computer 140 to display a view in three dimensions, given at least three different perspectives from sensors 120-123. Such a multidimensional analysis can be used to extract measurement data in different dimensions and/or along different axes, as was explained above with respect to FIGS. 3 and 4, for example. In such an instance, sensors 120-123 may be synchronized with respect to frame rate, so that sequential frames from each one of sensors 120-123 are for the same time frame.

Computer 140 is supplied with a computer program that analyzes the received images with respect to one or more bodies in the images. For example, the computer program may detect, identify or quantify a body or body portion in the received images. The body or portion can be assigned an identifier or tag, which may consist of a unique identifier. The identifier may be used to identify the body or portion through a series of images, which can permit real-time tracking. For example, as images are received from sensors 120-123 in real-time, bodies can be identified in the images in real-time and analyzed in real-time. If an individual is represented in the images, they can be identified in each image and examined for force that is experienced in real-time.

According to an example, computer 140 analyzes the images and identifies one or more points on the body captured in the images to be used as targets for subsequent analysis. For example, computer 140 identifies certain anatomic structures of the body such as the head, shoulders, elbows, hips and knees (not exclusive of other anatomic regions) and designates them as target data collection points.

The movements of each of bodies 110 may be monitored separately or collectively by sensors 120-123 and computer 140. In the example of sensors 120-123 being implemented as digital imaging equipment, bodies 110 are captured in images obtained from sensors 120-123. Real-time digital video of the monitored bodies 110 are communicated to computer 140, for example via Bluetooth, WiFi or direct cable connection. Computer 140 can display the images captured by sensors 120-123, as captured or after being processed by computer 140. A user can view the displayed images at a console, for example, and make adjustments to the process for processing or analyzing the images, such as by ensuring that a same point on a body is properly or consistently identified in the series of images. The processing of images and analysis of the same can be done automatically, with or without the presence of an operator or user.

Computer programs on computer 140 analyze the images received from sensors 120-123 to identify anatomic targets on one or more of bodies 110. The identified anatomic targets are compared between images to detect and analyze changes in position. The changes in position, along with other parameters and/or data, such as time lapse between images, are used to calculate values for velocity, acceleration and/or force experienced at the anatomic targets of the bodies 110. According to an example, observed position changes or calculated velocity or speed and/or acceleration are converted into gravitational force (g-force) by the computer program. Changes position, speed and/or acceleration can be the result of impacts, collisions or falls, to name a few examples, and can be positive or negative in value.

The data collected from sensors 120-123 may be used to calculate a deceleration experienced by an individual as represented by one of bodies 110. Deceleration may be calculated utilizing the formula:

a=(v²−v₀²)/2sg (Equation 1)

In the formula provided in Equation 1, a is acceleration, which may be a negative value that would represent deceleration in this case, v₀ is an initial speed in a given direction before deceleration begins, v is a speed in the given direction at the end of deceleration, and s is the distance traveled during the deceleration. The use of g in this formula allows for the expression of the results in terms of multiples of acceleration due to gravity or g-force. One g-force is 9.812 m/s2 (10.73 yards/s2). When v is close enough to zero to be negligible, as may be the case when the individual or an anatomic target is brought to a stop by the deceleration, the formula in Equation 1 can be expressed as:

a=−v₀²/2sg (Equation 2)

Using the information captured by the digital imagers in the above example, velocity (directional speed) and stoppage distances are calculated using the formula in Equation 2. For example, if a wide receiver is running at 4 yards per second (3.658 m/s) and his head is brought to a halt in a straight line in a distance of 6 inches (0.152 m or 0.167 yards), the following deceleration can be calculated using Equation 2:

a=(−4)2/(2)(0.167)(10.73)=−4.46 g

In this example, the magnitude of the player's velocity change over time is 4.46 g, or more than four times that of normal acceleration due to gravity, which is 1 g. The force experienced by the player's head during the above described deceleration event can be expressed using Newton's second law of motion:

F=ma (Equation 3)

For example, if the player's head experiences an acceleration a with a magnitude of 4.46 g, the exerted force is F=(m)(4.46 g). According to this result, the player's head, and their brain, would experience 4.46 times more force than that which would be caused by decelerating over the distance of 6 inches with a deceleration magnitude equal to gravity alone. The average brain mass is 1200 gm (1.2 kg or 2.65 lbs) so the force acting on the brain in this example is (2.65)(4.46 g)=11.8 g, which is over eleven times that experienced from normal gravitational deceleration, as might be experienced with a fall to the ground from a height of 6 inches.

The above calculations in the above example are for linear motion, including position, velocity and acceleration. Often, in contact sports or in any circumstance where the body is accelerated, changes velocity or changes direction, movement or force is not consistent along a straight-line path. Thus, the force applied to the body may be multi-dimensional. If the position, velocity and acceleration is linear, the above formulas may be used to calculate acceleration and force in different directions or dimensions, and the calculated accelerations and/or forces can be added, such as with vector addition, to determine an overall acceleration and/or force. Similarly, equations for rotational or angular position, velocity and/or acceleration may be used to calculate angular acceleration and/or torque in one or more dimensions and the results may be combined, such as with vector addition, to obtain an overall acceleration or torque.

G-force thresholds may be specified in computer 140, and may be based on various criteria, including age-specific thresholds. For example, thresholds for younger individuals may be lower than thresholds used for older individuals. The thresholds are related to g-forces that might be suggestive of concussive type injury. Computer 140 can collect and store data related to the number of separate g-force events experienced by each individual being monitored in area 100. These events, which may be referred to as a ‘hit count’ are saved and may be managed to be part of an individual's permanent record. For example, the hit count from a high school football player can be collected and stored and carry over to his college career and then on to his professional career. Such management of hit count history permits the player to be associated with a life-time hit count. The hit count data can be used to predict outcome from repetitive head trauma or retrospectively analyzed to determine a relationship between hit count and lingering concussion symptoms or disability.

When a g-force that approaches a concussion threshold is detected by the computer surveillance system illustrated in FIG. 1, an alert may be issued. The alert may be displayed on the display for computer 140 and conveyed to the participant, a coach or other persons tasked with managing health or safety of the participant. For example, a push notification may be sent to a coach, trainer or parent via a communication network, which may include a local wireless network. The push notification can be received via email, text message or through the use of a mobile application. If an operator or user is present at the display for computer 140, they can alert the appropriate staff of the situation, for example by using texting, email, a mobile application, phone call or two-way radio. After the alert is issued, the participant may be encouraged or required to be removed from play and evaluated for concussion symptoms.

The presently disclosed techniques may also be applied to previously recorded video footage. For example, recorded video may be available from a number of cameras that were located at various different locations for recording a sporting event from different angles and perspectives. The recorded video can be analyzed in accordance with the implementations and techniques described herein to determine a level of force applied to one or more participants or anatomic parts of such participants. For example, video footage from a hockey game where a player experienced a collision that may have resulted in a concussion can be analyzed during or after the game using the techniques discusses herein. The player can be determined to have an applied g-force based on calculations conducted by computer 140 (FIG. 1) for example. The analysis can be applied to video image data collected from games that may have occurred years in the past or just hours ago, as long as the parameters of the video image data are known, for example the frame rate and position of the camera. Such retrospective analysis and results can guide treatment plans for clinicians and aid in the treatment of the player. The analysis and results can also be recorded in the medical records for the player or the team, and assist in calculating ‘hit counts’ or the number of head injuries. Video footage that can be analyzed includes television recordings, video recordings from handheld devices such as mobile phones or tablets, or team supplied film, such as ‘coaches film.’ Other recorded image or sensor data can also be used with the disclosed techniques and implementations.

The techniques and implementations described herein may be provided as a service, with multiple different levels of results or product being provided, depending on the desires of the user. For example, a professional package may be provided as a first tier that uses a relatively large number of sensors spaced around the area of interest, such as a sporting venue, from different angles and potentially utilizing moving sensors and/or sensors suspended from a ceiling or other overhead structure. The relatively large number of sensors tends to increase the sensitivity, precision and/or accuracy of the data collected. The systems and methods disclosed herein can be used and applied with any number of sensors. The number of sensors, such as digital imagers, may be dependent on the size of the venue. For example, an NFL stadium may be provided with a greater number of digital imagers than an NHL arena.

The professional package may, for example, utilize available video equipment to obtain images, such as video equipment provided by television networks for live televised feeds or provided for the purpose of play review. Data collected from such available video equipment that is positioned around the sporting venue, is sent to computer 140. The disclosed techniques and implementations may provide an interface to receive images from such video equipment by, for example, computer 140. Computer 140 may also provide an API that can be accessed by the video equipment to provide the desired images. The images received by computer 140 are analyzed in accordance with the techniques described above. The data collected from the video equipment for live television feeds can also be supplemented by data collected from additional imagers. Data from the additional imagers may be collected by computer 140 using wireless communications. The number of anatomic targets can be arbitrarily specified within the capacity of the equipment and computer programming. For sporting events that have the potential for a relatively large number of anatomic targets, such as may be the case in professional football, the disclosed implementations and techniques can be provided with suitable capacity to manage the data collection and analysis. For example, high performance processors or computers may be used to collect and process data related to a large number of anatomic targets in real-time. The cost of such high performance processors or computers may be greater than a nominal system, however, the greater cost may be justified in the context of a professional sport that has significant revenues. The professional package may be used in any venue, including professional, collegiate, high school, little league, club or intramural.

Another level of service that has results or products that may be less comprehensive than the professional package may be provided as a second tier, directed to a collegiate package. The collegiate package uses fewer sensors, which may be imaging devices, than the professional package. The processors or computers used in the collegiate package may be lower performance than those of the professional package, which may reduce cost and/or complexity. The collegiate package may be implemented as a system that can detect a greater number, a same number or a fewer number of anatomic targets than the professional package. With fewer sensors, the accuracy of the collegiate package may not be as strong as the accuracy of the professional package. The collegiate package may be used in any venue, including professional, collegiate, high school, little league, club or intramural.

Another level of service that has results or products that may be less comprehensive than the collegiate package may be provided as a third tier, directed to a community package. The community package may use fewer sensors, which may be imaging devices, than the collegiate package. The processors or computers used in the community package may be lower performance than those of the collegiate package, which may reduce cost and/or complexity. The community package can be implemented as a system that can detect a same number or a fewer number of anatomic targets than the collegiate package. With fewer sensors, the accuracy of the community package may not be as strong as the accuracy of the collegiate package. The community package may be used in any venue, including professional, collegiate, high school, little league, club or intramural. The community package may be more appropriate for venues that are community oriented and/or smaller than a collegiate setting, including venues such as, but not exclusive to, playgrounds, skateboard parks, town ice skating rinks, and back yards.

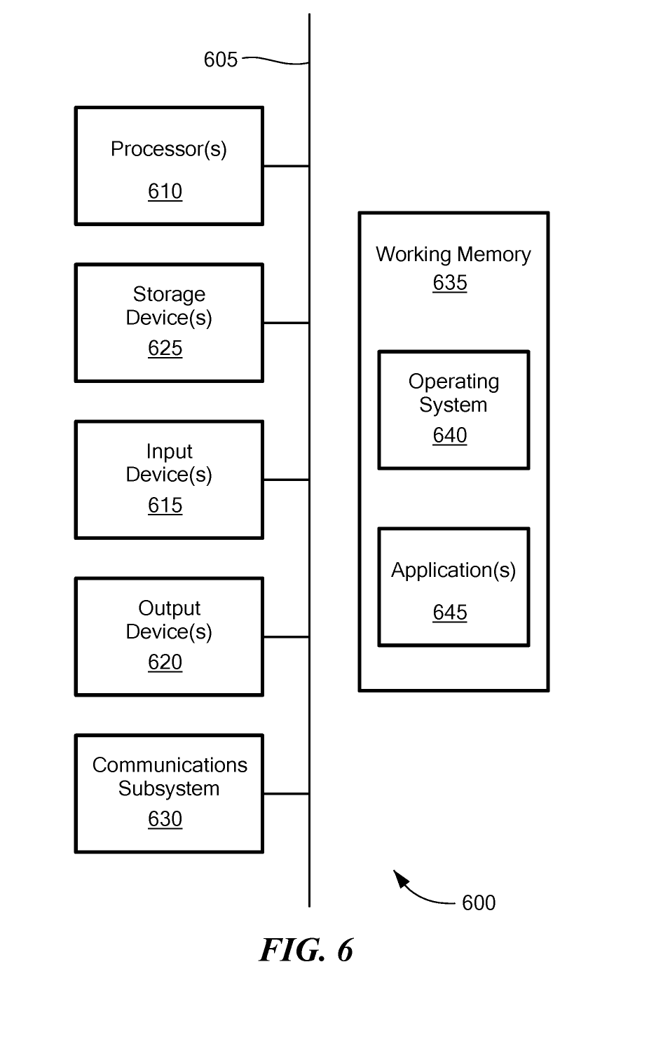

FIG. 6 illustrates an example computer system 600. Computer system 600 may be used for all or part of the previously described computerized devices or systems, including computer 140. FIG. 6 provides a schematic illustration of an example of a computer system 600 that can perform the methods provided by various other examples, as described herein, and/or can function as the host computer system, a remote kiosk/terminal, a mobile device, and/or a computer system. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

Computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

Computer system 600 may further include (and/or be in communication with) one or more non-transitory storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

Computer system 600 might also include a communications subsystem 630, which can include without limitation a modem, a network card (wireless or wired), an infrared communication device, a wireless communication device and/or chipset (such as a Bluetoothä device, an 802.11 device, a WiFi device, a WiMax device, cellular communication facilities, etc.), and/or the like. Communications subsystem 630 may permit data to be exchanged with a network (such as the network described below, to name one example), other computer systems, and/or any other devices described herein. In some example implementations, computer system 600 includes a working memory 635, which can include a RAM or ROM device, as described above.

Computer system 600 also can include software elements, shown as being currently located within working memory 635, including an operating system 640, device drivers, executable libraries, and/or other code, such as one or more application programs 645, which may include computer programs discussed in various examples, and/or may be designed to implement methods, and/or configure systems, provided by other examples, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as storage device(s) 625 described above. In some cases, the storage medium might be incorporated within a computer system, such as system 600. In other examples, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by computer system 600 and/or might take the form of source and/or installable code, which, upon compilation and/or installation on computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, some examples may employ a computer system (such as computer system 600) to perform methods in accordance with the present disclosure. According to a set of examples, some or all of the procedures of such methods are performed by computer system 600 in response to processor 610 executing one or more sequences of one or more instructions (which might be incorporated into operating system 640 and/or other code, such as an application program 645) contained in working memory 635. Such instructions may be read into working memory 635 from another computer-readable medium, such as one or more of the storage device(s) 625. Merely by way of example, execution of the sequences of instructions contained in working memory 635 might cause processor(s) 610 to perform one or more procedures of the methods described herein.

The terms “machine-readable medium” and “computer-readable medium,” as used herein, refer to any medium that participates in providing data that causes a machine to operate in a specific fashion. In an example implemented using computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as storage device(s) 625. Volatile media include, without limitation, dynamic memory, such as working memory 635. Transmission media include, without limitation, coaxial cables, copper wire and fiber optics, including the wires that include bus 605, as well as the various components of communication subsystem 630 (and/or the media by which communication subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 600. These signals, which might be in the form of electromagnetic signals, acoustic signals, optical signals and/or the like, are all examples of carrier waves on which instructions can be encoded, in accordance with the present disclosure.

Communications subsystem 630 (and/or components thereof) generally receives the signals, and bus 605 then might carry the signals (and/or the data, instructions, etc. carried by the signals) to working memory 635, from which processor(s) 605 retrieves and executes the instructions. The instructions received by working memory 635 may optionally be stored on a storage device 625 either before or after execution by processor(s) 610.

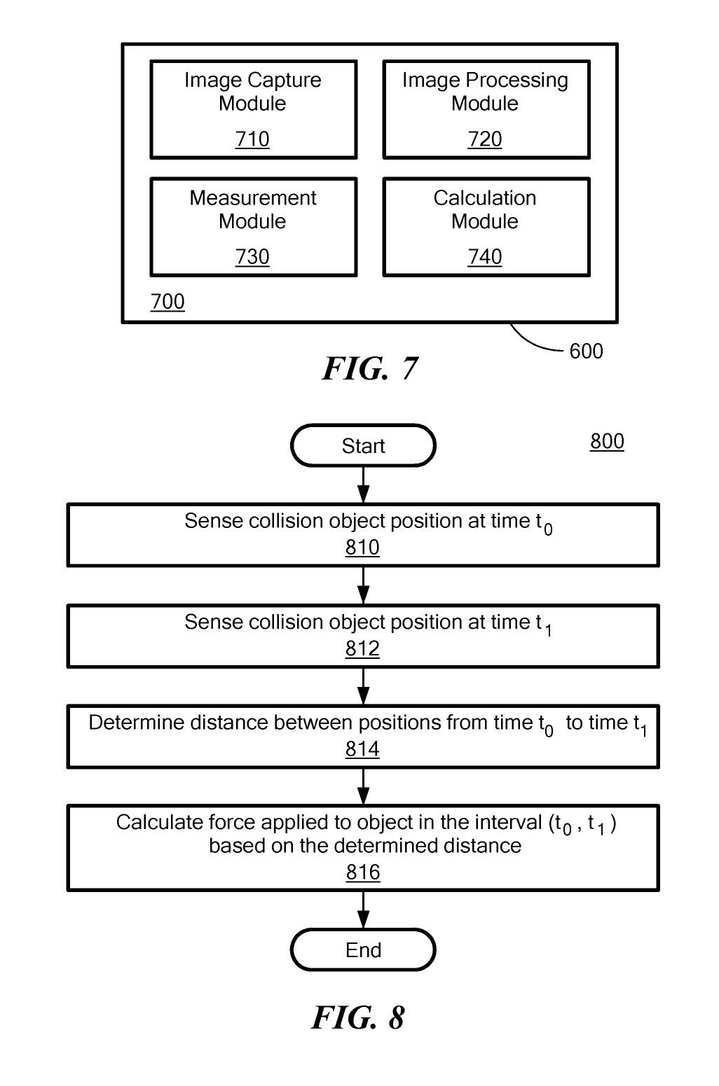

Referring to FIG. 7, computer system 600 is represented as being capable of implementing modules to perform some or all of the functions described above with an example platform 700. Platform 700 includes an image capture module 710, an image processing module 720, a measurement module 730 and a calculation module 740. Modules 710, 720, 730 and 740 are functional modules implemented by processor(s) 610 and application(s) 645 stored in working memory 635 or by computer 140, for example. Thus, modules 710, 720, 730 and 740 represent the performance of or configuration to perform functions discussed above using processor(s) 610 or computer 140, which may be configured to perform the function in accordance with application(s) 645 (and/or firmware, and/or hardware of processor(s) 610). Similarly, reference to processor(s) 610, or any other device discussed above, performing an image capture, image processing, a measurement or a calculation function, is equivalent to image capture module 710, image processing module 720, measurement module 730 or calculation module 740 performing the function.

Referring to FIG. 8, a flowchart 800 illustrates an example of a method for determining collision forces applied to an object involved in a collision. Block 810 illustrates sensing of a position of the object at time t₀. Block 812 illustrates sensing of a position of the object at time t₁. The sensing illustrated in blocks 810 and 812 may be implemented according to any of the above noted techniques for sensing position. The technique illustrated in flowchart 800 assumes that the object changes position in at least one dimension of a coordinate system, such as one or more of the coordinate systems discussed above.

Block 814 illustrates a determination of distance between the positions of the object sensed at times t₀ and t₁, respectively. The distance determination may be a scalar or a vector that represents absolute distance, or may be represented in a coordinate system with multiple dimensions, as examples. As illustrated in block 816, the method illustrated in flowchart 800 calculates the force applied to the object in the interval (t₀, t₁) based on the distance determined in block 814. The force may be calculated according to any of the techniques discussed above. The calculated force may then be used to determine if a threshold level of force was applied to the object involved in the collision. Such determinations may be used to decide if an individual, as the object in the collision, was exposed to injurious or damaging force, and in particular, concussive force.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

The above elements may be components of a larger system, wherein other rules may take precedence over or otherwise modify the implementation or techniques discussed herein. Also, or in addition, a number of steps may be undertaken before, during, or after the above elements are considered.

As used herein, “or” as used in a list of items prefaced by “at least one of” indicates a disjunctive list such that, for example, a list of “at least one of A, B, or C” means A alone, or B alone, or C alone, or AB, or AC, or BC, or ABC (i.e., A and B and C), or combinations with more than one of the same feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include that the information is conveyed from a sending entity but does not reach an intended recipient of the information. The intended recipient, even though not actually receiving the information, may still be referred to as a receiving entity, e.g., a receiving execution environment.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A method for remotely determining force applied to an object, comprising:
remotely sensing a first position of the object at a first time;
remotely sensing a second position of the object at a second time that is later than the first time by an elapsed time;
determining a distance between the first position and the second position; and
calculating a force applied to the object using the distance and the elapsed time.

2. The method according to claim 1, wherein remotely sensing further comprises capturing an image that includes at least a portion of the object.

3. The method according to claim 2, further comprising determining a distance resolution of the image in a region of the image that includes at least the portion of the object.

4. The method according to claim 3, further comprising:
capturing a first image of at least the portion of the object at the first position;
determining a first distance resolution for at least the portion of the object in the first image;
capturing a second image of at least the portion of the object at the second position;
determining a second distance resolution for at least the portion of the object in the second image;
determining the distance between the first position and the second position by interpolating a distance measurement between at least the portion of the object in the first image and at least the portion of the object in the second image in accordance with the first distance resolution and the second distance resolution.

5. The method according to claim 1, further comprising detecting a collision between the object and another object during an interval between the first time and the second time.

6. The method according to claim 1, further comprising comparing the force with a threshold and determining a status of the object when the force is beyond the threshold.

7. The method according to claim 1, further comprising determining the first position and the second position within a coordinate system.

8. The method according to claim 1, further comprising identifying indicia related to a position of the object to contribute to sensing one or more of the first position or the second position.

9. The method according to claim 2, further comprising tracking the object to contribute to capturing the image.

10. The method according to claim 1, further comprising detecting a position of at least one sensor used to sense one or more of the first position or the second position.

11. The method according to claim 2, further comprising calibrating an image capture device for capturing the image by analyzing known indicia in the image.

12. The method according to claim 1, further comprising detecting a sensing field to contribute to sensing one or more of the first position or the second position.

13. The method according to claim 1, further comprising sensing the first position and the second position in real-time to permit the force to be calculated in real-time.

14. The method according to claim 1, further comprising storing the calculated force in a memory.

15. A system for remotely determining force applied to an object, comprising:
a sensor for remotely sensing a position of the object;
a computer communicatively coupled to the sensor and configured to receive position data from the sensor;
the computer being configured to execute instructions from a memory to:
receive a first position of the object at a first time;
receive a second position of the object at a second time that is later than the first time by an elapsed time;
determine a distance between the first position and the second position; and
calculate force applied to the object using the distance and the elapsed time.

16. The system according to claim 15, wherein the sensor further comprises an image capture device configured to capture an image that includes at least a portion of the object.

17. The system according to claim 16, further comprising an instruction module in the memory that is executable to determine a distance resolution of the image in a region of the image that includes at least the portion of the object.

18. The system according to claim 15, further comprising an instruction module in the memory that is executable to compare the force with a threshold and to determine a status of the object when the calculated force is beyond the threshold.

19. The system according to claim 15, further comprising a position detector being coupled with the sensor for detecting a position of the sensor used to sense one or more of the first position or the second position.

20. A method for remotely detecting force applied to an object, comprising:
remotely detecting one or more of a position, velocity or acceleration of the object over an interval of time in conjunction with a collision of the object with another object;
determining a force associated with the collision applied to the object over the interval of time; and
determining a status of the object in accordance with whether the force is beyond a threshold.
